(19) United States
(12) Patent Application Publication
(10) Pub. No.: US 2005/0069355 A1
(43) Pub. Date: Mar. 31, 2005

(54) Image forming apparatus and image forming method

(75) Inventors: Takeshi Watanabe, Kanagawa-ken (JP); Masashi Hiroki, Kanagawa-ken (JP); Masashi Takahashi, Kanagawa-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/946,377

(22) Filed: Sep. 22, 2004

(30) Foreign Application Priority Data
Sep. 30, 2003 (JP) 2003-340902

(51) Int. Cl. G03G 21/10

(52) U.S. Cl. 399/343

(57) ABSTRACT

In an image forming apparatus using the cleaner-less processing, a developer vent is provided to a developing device so as to discharge paper dust mixing in the developing device together with developer comprising carrier and toner or carrier only through the developer vent, when removing residual toner.

### CROSS-REFERENCE TO RELATED APPLICATIONS

This application is based upon and claims the benefit of priority from prior Japanese Patent Application No. 2003-340902, filed Sep. 30, 2003; the entire contents of which are incorporated herein by reference.

### BACKGROUND OF THE INVENTION

1. Field of the Invention

The present invention relates to an image forming apparatus that uses two-component developer comprising toner and carrier and an image forming method.

2. Description of the Related Art

An image forming technology utilizing a cleaner-less process is widely known and practically used. In this cleaner-less process, a developing device recovers residual toner on a photosensitive drum. However, paper powder of transfer materials and peripheral dust are also recovered, causing such a trouble that they are mixed into developer in a developing device. As a countermeasure to this problem, a technology to get a clear image without being affected by powder of transfer materials using developer after mixing with the recovered powder and stirring the mixture thoroughly for the image forming is disclosed in Japanese Published Patent Application No. 2000-321875.

However, when paper dust mixed in developer is increasing, even when dispersed in a developing device, developer deteriorated and in mixed colors may adversely affect an image. It is therefore necessary for continuously forming clear images to prevent paper dust from mixing in developer or to eliminating mixed paper dust.

### SUMMARY OF THE INVENTION

It is an object of the present invention to provide an image forming apparatus and an image forming method capable of continuously forming clear images by sufficiently and efficiently eliminating toners mixed with paper dust or other color toners mixed in a developing device of an image forming apparatus for forming images using two-component developer and utilizing a cleaner-less process.

According to an aspect of the present invention, an image forming apparatus is provided, which comprises an image carrier; a main charger to uniformly charge the image carrier; an exposure unit to form an electrostatic latent image by exposing the image carrier charged by the main charger; a developing device, having a developer vent and a developer replenishing port to replenish developer to the developing device, to form a toner image by developing the electrostatic latent image on the image carrier with two-component developer including toner and carrier; and a transfer unit to transfer the toner image onto an image receiving medium, wherein the developing device removes residual toner remained on the image carrier after transferring the toner image by the transfer unit and discharges paper dust mixed into the developing device when removing the residual toner through the developer vent together with the carrier.

Further, according to an aspect of the present invention, an image forming method is provided, which comprises uniformly charging an image carrier; forming an electrostatic latent image by exposing the charged image carrier; forming a toner image by developing the electrostatic latent image using two-component developer including toner and carrier by a developing device having a developer vent; transferring the toner image onto an image receiving medium; and removing residual toner remaining on the surface of the image carrier after transferring the toner image and discharging paper dust mixed in the developing device when removing the residual toner together with developer or the carrier through the developer vent.

### BRIEF DESCRIPTION OF THE DRAWINGS

FIG. 1 is a block diagram showing an embodiment of the image forming apparatus of the present invention;

FIG. 2 is a schematic diagram showing an image forming unit of the image forming apparatus shown in FIG. 1;

FIG. 3 is a sectional view when viewed from above of the developing device that is used in the image forming unit shown in FIG. 2:

FIG. 4 is a schematic sectional viewed when viewed from the left of the developing device shown in FIG. 3;

FIG. 5 is a first graph showing a photosensitive drum, a developing roller, potential of a transfer unit, and movement of toner;

FIG. 6 is a second graph showing a photosensitive drum, a developing roller, potential of a transfer unit, and movement of toner;

FIG. 7 is a third graph showing a photosensitive drum, a developing roller, potential of a transfer unit, and movement of toner;

FIG. 8 is a fourth graph showing a photosensitive drum, a developing roller, potential of a transfer unit, and movement of toner;

FIG. 9 is a fifth graph showing a photosensitive drum, a developing roller, potential of a transfer unit, and movement of toner;

FIG. 10 is a sixth graph showing a photosensitive drum, a developing roller, potential of a transfer unit, and movement of toner;

FIG. 11 is a seventh graph showing a photosensitive drum, a developing roller, potential of a transfer unit, and movement of toner;

FIG. 12 is an eighth graph showing a photosensitive drum, a developing roller, potential of a transfer unit, and movement of toner;

FIG. 13 is a ninth graph showing a photosensitive drum, a developing roller, potential of a transfer unit, and movement of toner;

FIG. 14 is a rough sectional view showing a processing unit equipped with a cleaner;

FIG. 15 is a graph showing the relation between scraping amount of the photosensitive drum surface and the number of forming images;

FIG. 16 is a rough sectional view of a developing device provided with a developer pool portion;

FIG. 17 is a rough section view of a developing device provided with a magnetic seal at the developer vent;

FIG. 18 is a rough sectional view showing a processing unit provided with a toner removing mechanism comprising an elastic roller, a brush roller and a contact member;

FIG. 19 is a rough sectional view of a processing unit provided with a toner removing mechanism comprising an elastic roller, a removing roller and a removing blade;

FIG. 20 is a rough sectional view showing a processing unit provided with a toner removing mechanism comprising a brush roller and a contact member;

FIG. 21 is a rough sectional view showing a processing unit provided with a toner removing mechanism comprising an elastic roller and a brush roller; and

FIG. 22 is a flowchart of the voltage control to remove toner adhered to a brush roller.

### DETAILED DESCRIPTION OF THE INVENTION

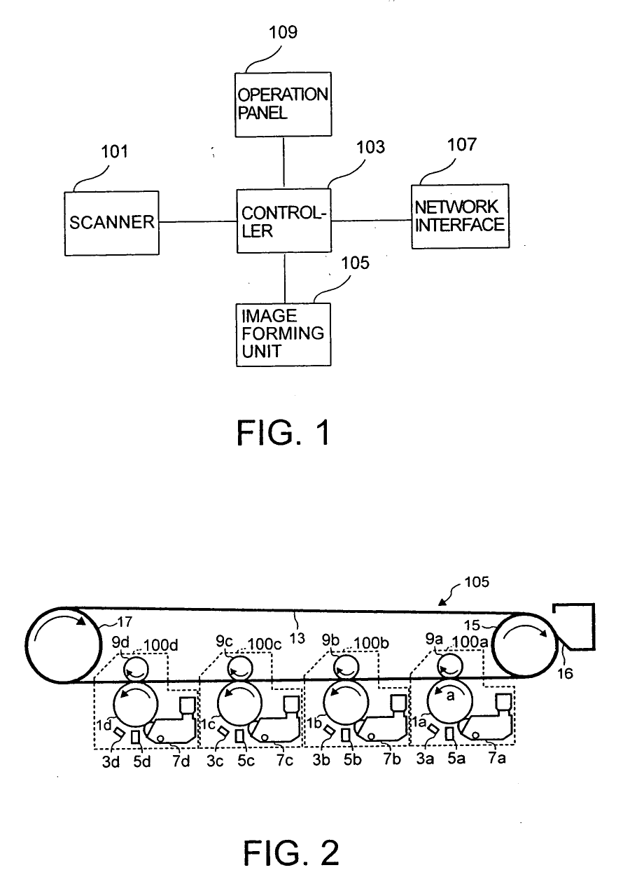

A first embodiment of the present invention will be explained below referring to the attached drawings. FIG. 1 is a block diagram of an image forming apparatus. A document image is read by a scanner 101 and image data generated based on color data of red, green and blue of the document image is sent to a controller.

Controller 103 controls the operation of the image forming apparatus and further, executes the image data processing and the dimensional computation of respective color images that are formed in the respective processing units which are described later.

Controller 103 is connected with a network interface 107 which is connected to external networks including LAN and Internet and receives image data/instructions relative from the external activities and sends out the status information of the image forming apparatus to the external activities.

Further, controller 103 is connected with an operation panel 109 attached to the image forming apparatus and through which instructions relative to the operation of the image forming apparatus may be obtained.

Further, controller 103 is connected with an image forming unit 105 and a toner image is formed on a paper based on image data.

FIG. 2 is a schematic diagram of image forming unit 105. Image forming unit 105 is equipped with a first processing unit 100a to form yellow toner images, a second processing unit 100b to form magenta toner images, a third processing unit 100c to form cyanic toner images, a fourth processing unit 100d to form black toner images, and a conveyor belt 13 to convey paper.

Conveyor belt 13 is rotated by a driven roller 15 and a drive roller 17. For conveyor belt 13 to convey paper from the upstream side to the downstream sir by rotating, first processing unit 100a, second processing unit 100b, third processing unit 100c and fourth processing unit 100d are arranged from the upstream side.

Conveyor belt 13 is rotated at a velocity almost equal to the peripheral velocity of a photosensitive drum 1a. A belt cleaner 16 for removing toners adhered to conveyor belt 13 is provided at the downstream side from forth processing unit 100d but at the upstream side from first processing unit 100a in the rotating direction of conveyor belt.

In this embodiment, all processing units are in the same structure and therefore, the structure of first processing unit 100a will be described as a representative example.

First processing unit 100a is composed of photosensitive drum 1a, a main charger 3a, an exposure unit 5a, a developing device 7a, and a transfer unit 9a.

Photosensitive drum 1a which is a first image carrier is a cylindrical laminated type organic photo conductor. This photosensitive drum 1a rotates in sync with the peripheral velocity of conveyor belt 13 in the arrow direction a in the figure. Around photosensitive drum 1a, main charger 3a, exposure unit 5a, developing device 7a and transfer unit 9a are arrange in order in the rotating direction of photosensitive drum 1a.

Main charger 3a is opposing to photosensitive drum 1a and minus charges the surface of photosensitive drum 1a by corona discharge. Exposure unit 5a equipped with such a light emitter as LED is opposing to the part of photosensitive drum 1a charged by main charger 3a, exposes and forms an electrostatic latent image thereon when photosensitive drum 1a is rotated. Developing device 7a is opposed to the part of photosensitive drum 1a exposed by exposure unit 5a when photosensitive drum 1a is rotated and develops the electrostatic latent image to a toner image. At the position where the toner image of the electrostatic latent image developed by developing device 7a is opposed to a paper conveyed by conveyor belt 13, transfer unit 9a electrically sucks in the toner image from the reverse side of conveyor belt 13 and transfers it on the paper.

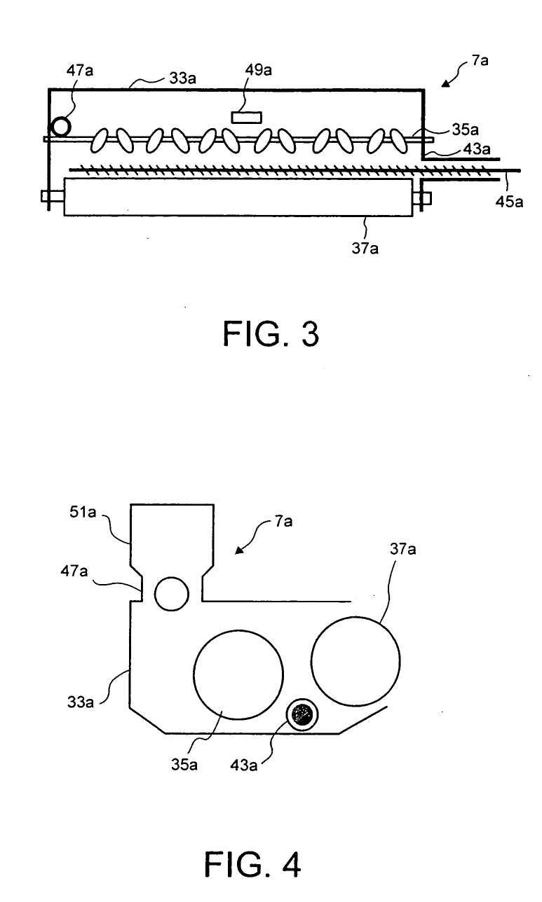

Developing device 7a will be described below in detail. FIG. 3 is a diagram showing the rough sectional view of developing device 7a viewed from above. Developing device 7a has a developer container 33a containing developer comprising toner and carrier. In the inside of developer container 33, an agitating roller 35a is provided to agitate toner.

Toner is taken out from developer container 33a and an electrostatic latent image is developed by a developing roller 37a that is composed of a magnet roller and provided along the lateral direction of developer container 33a. Toner density of developer in developing container 33a is monitored by a toner density detector 49a comprising a magnetic sensor/optical sensor.

As shown in the rough sectional view of developing device 7a viewed from the left in FIG. 4, a developer vent 43a is provided on the side of developer container 33a and developer in developer container 33a is conveyed to this developer vent 43a when an auger 45a provided parallel to developing roller 37a is rotated. Further, there is provided a developer replenishing port 47a on the top of developer container 33a and developer can be replenished into developer container 33a from a developer cartridge 51a.

When toner is consumed by the development and atoner density detector detects that toner density dropped below a specified density, auger 45a rotates and discharges developer in developing container 33a through developer vent 43a and developer is replenished from developer replenishing port 47a.

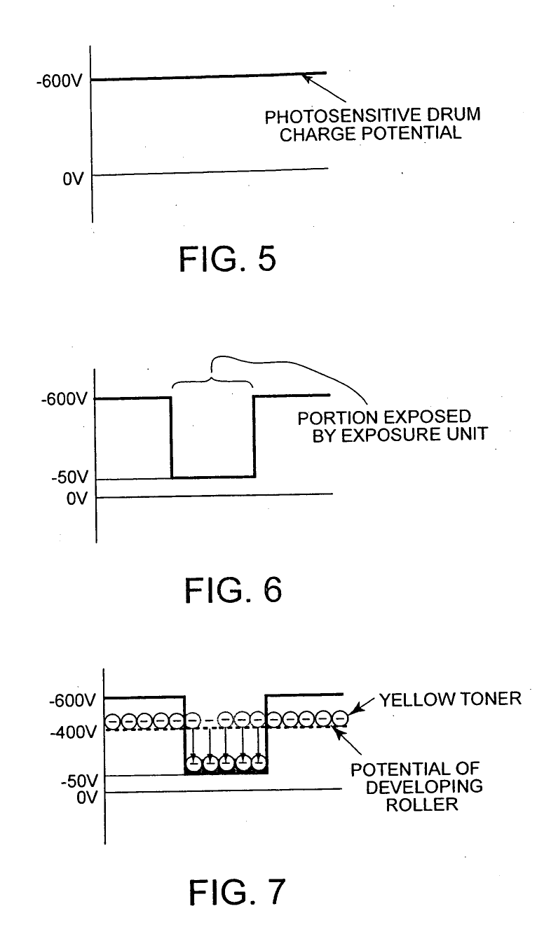

The image forming operation of an image forming apparatus equipped with first processing unit 100a equipped with developing device 7a in the structure described above and second to fourth processing units 100b to 100d which are in the similar structure as first processing unit 100a will be explained referring to FIG. 5 to FIG. 13.

FIG. 5 to FIG. 13 show how toner is moved for respective potentials of first processing unit 100a, photosensitive drum 1a, developing roller 37a and transfer unit 9a.

When photosensitive drum 1a begins to rotate in first processing unit 100, the surface of photosensitive drum 1a is charged uniformly by main charger 3a. This charge voltage is about −600V in this embodiment (FIG. 5).

When photosensitive drum 1a is rotated and the charged portion of the surface of photosensitive drum 1a is faced to exposure unit 5a, the surface of photosensitive drum 1a is exposed by exposure unit 5a and an electrostatic latent image is formed thereon based on an yellow image data. The potential of this electrostatic image portion is about −50V in this embodiment (FIG. 6).

When photosensitive drum 1a is rotated and the charged portion of the surface of photosensitive drum 1a is faced to developing device 7a, an electrostatic latent image formed on the surface of photosensitive drum 1a is developed by developing device 7a to a toner image in yellow system toner that is sufficiently minus charged in advance in developing device 7a. In this embodiment, bias voltage is applied to developing roller 37a and potential becomes about −400V (FIG. 7).

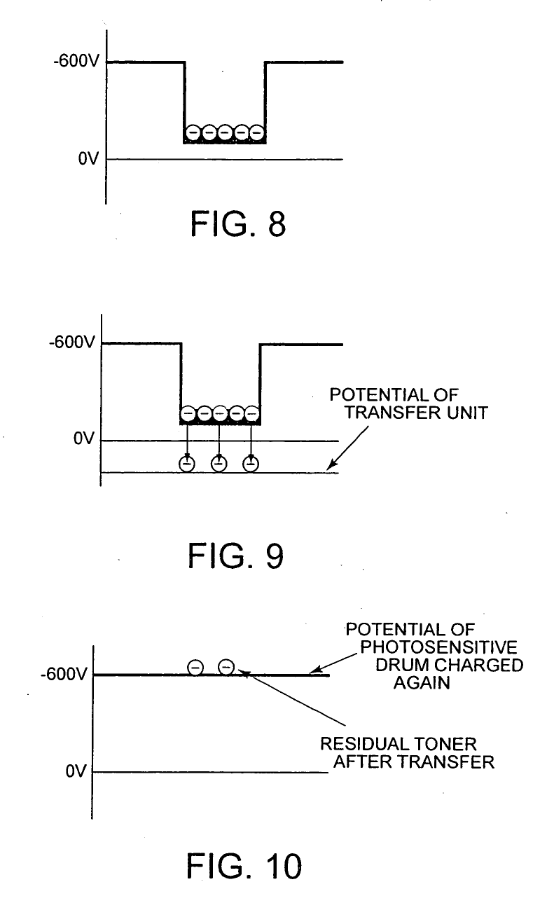

Toner is moved from developing device 7a to the portion of photosensitive drum 1a exposed by exposure unit 5a and remained thereon (FIG. 8).

When photosensitive drum 1a is rotated and conveyor belt 13 is rotated and is faced to a paper arrived to a specified position, transfer current is flown to transfer unit 9a. Then, an electric field is formed between transfer unit 9a and photosensitive drum 1a and a toner image formed on the surface of photosensitive drum 1a is transferred on a paper passing between transfer unit 9a and photosensitive drum 1a by this electric field (FIG. 9).

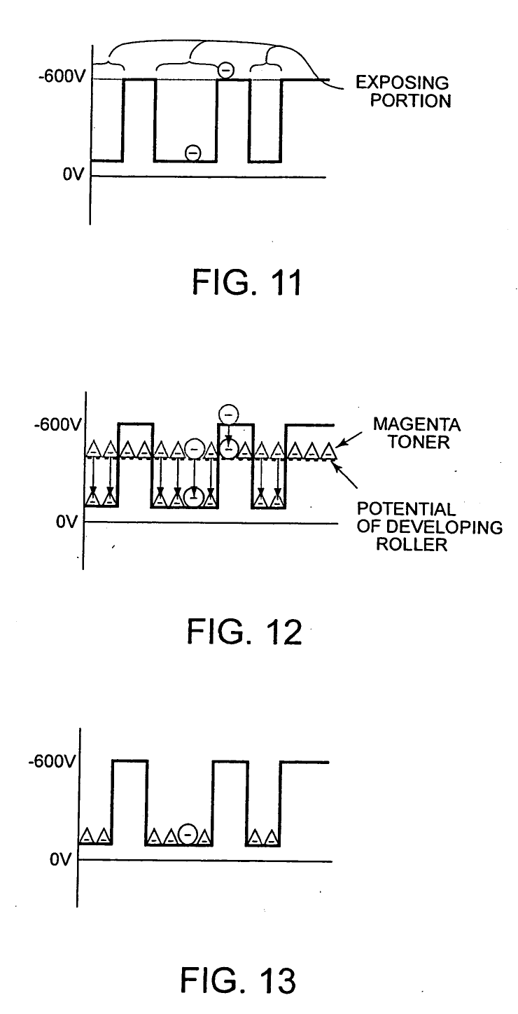

The portion of photosensitive drum 1a with toner adhered and not transferred on a paper is charged again by main charger 3a (FIG. 10), exposed by exposure unit 5a and an electrostatic latent image is formed (FIG. 11).

When developing device 7a develops this electrostatic latent image, photosensitive drum 1a is charged to about −50V at the electrostatic latent image forming portion and about −600V at the non-forming portion and therefore, toner moves from developing roller 37a charged to about −400V to the electrostatic latent image forming portion of photosensitive drum 1a and on the other hand, toner moves from the electrostatic latent image non-forming portion to developing roller 37a (FIG. 12). As a result, residual toner on photosensitive drum 1a is collected to developing device 7a and toner is given to the electrostatic latent image formed on photosensitive drum 1a. This is the cleaner-less process (FIG. 13).

Such a processing is executed in second fourth processing units 100b to 100d and magenta, cyanic and black toner images are superposed on a sheet on which a yellow toner image is formed by first processing unit 100a.

In first processing unit 100a, there is a problem generated in the process to form images, wherein paper dust on paper is reverse transferred on photosensitive drum 1a and collected in developing device 7a jointly with toner left on the surface of photosensitive drum 1a without transferred on paper and as a result, paper dust is mixed in developer in developing device 7a.

In first processing unit 100a, in order to decrease density of developer containing mixed paper dust, developer in developing device 7a is discharged through developer vent 43a and fresh developer is replenished into developer container 33a through developer replenishing port 47a.

Toner density of developer contained in developer container 33a is monitored by toner density detector 49a. When the image forming is carried out successively and toner density of developer in developer container 33a drops to below a specified level, developer in toner density higher than the above-mentioned specified density containing not only toner but also carrier is replenished until developer in developer container 33a becomes a specified toner density. Developer in developer container 33a increased by the amount of developer newly replenished is discharged through developer vent 43a.

In second to fourth processing units 100b to 100d to superpose toner images developed respectively on a paper having an image formed in first processing unit 100a, not only paper dust but also other color toners from toner images previously formed on the paper are inversely transferred and mixed in developers in developer containers 33b to 33d. As a countermeasure against this, developers are replenished and discharged likewise first processing unit 100a.

Thus, by replenishing new developers into developer containers and discharging old developers, it becomes possible to lower density of paper dust and other color toners mixed into developers in developer containers and successively form clear images.

To replenish not only toner but also developer comprising toner and carrier through the developer replenishing port, it is only necessary to connect only a cartridge containing a developer to the developer replenishing port. However, in order to increase toner density of developer in the developer container, it is necessary to discharge developer through the developer vent and is uneconomical because developers must be discharged even when amounts of paper dust and other color toners mixed in developer are less or when carrier is less damaged. So, cartridges containing toner and carriers, respectively may be provided and amount of toner or carrier supplied from these cartridges may be independently controlled.

Next, the method to discharge developer of the developing device will be described.

The control to replenish a developer of high toner density and discharge developer by the amount of added developer based on the toner density in the developer container is as described above. In addition to this, for example, after forming an image having relatively wide white portion, it is better to make the replenishing and discharge of developer. When an image having a wide white portion is formed, amount of paper dust mixed into the developer container relatively increases and it is therefore to discharge mixed paper dust.

Furthermore, it is better to replenish and discharge developer according to the number of sheets to form images. For example, when images having a low printing rate are frequently formed in first processing unit 100a at the upstream, even when paper dust is taken in developer container 33b from paper surfaces and accumulated there, toner density not much drop in developer containers 33b and developer may not be discharged in second processing unit 100b. In third to fourth processing units 100c to 100d, the similar phenomena may be generated and to avoid this, it may be advisable to replenish a specified amount of developer and to discharge developer by the increased amount after the image formation is made for a specified number of sheets. Thus, it becomes possible to solve such a problem that developer is not discharged even when paper dust is mixed.

In addition to the above-mentioned construction to discharge developer through the developer vent, it may be better to consume and discharge toner by developing an electrostatic latent image of 100% of printing ratio; that is a solid electrostatic latent image formed on photosensitive drum.

This is economical because paper dust and toner only can be discharged while leaving carrier contained in developer in a developer container.

A solid toner image can be formed anytime other than an ordinary image forming timing; that is, at other than non-printing operation. For example, a solid image may be formed immediately after completing the image formation based on image data sent from controller 103 and before starting the image formation based on next image data.

When executing the image formation successively for many sheets, it may be performed after completing a series of image forming operations. Or, the operations may be so controlled that a series of image forming operations are interrupted on the way and restarted after cleaning developer by forming a solid toner image.

Solid toner images formed here may be checked for defects by transferring on paper as an image receiving medium. However, if no confirmation is required, paper is wasted and therefore, using conveyor belt 13 as an image receiving medium, the solid toner image may be transferred on conveyor belt 13 and toner may be recovered with a belt cleaner.

In this embodiment, an image forming apparatus in the structure to transfer toner images on sheets of paper conveyed by conveyor belt 13 directly from first to fourth processing units 100a to 100d is described. This invention, however, may be applicable to an apparatus in such a structure that toner images in respective colors are superposed on an intermediate image receiving medium and transferred on sheets of paper on the conveyor belt. In this case, solid toner images transferred on the intermediate image receiving medium may be removed by a means to clean the intermediate image receiving medium or further transferred to a sheet of paper or the conveyor belt from the intermediate image receiving medium.

Next, a second embodiment will be described. Here, the second embodiment will be explained taking developing device 7a as an example but needless to say, this is also applicable to developing devices 7b to 7d.

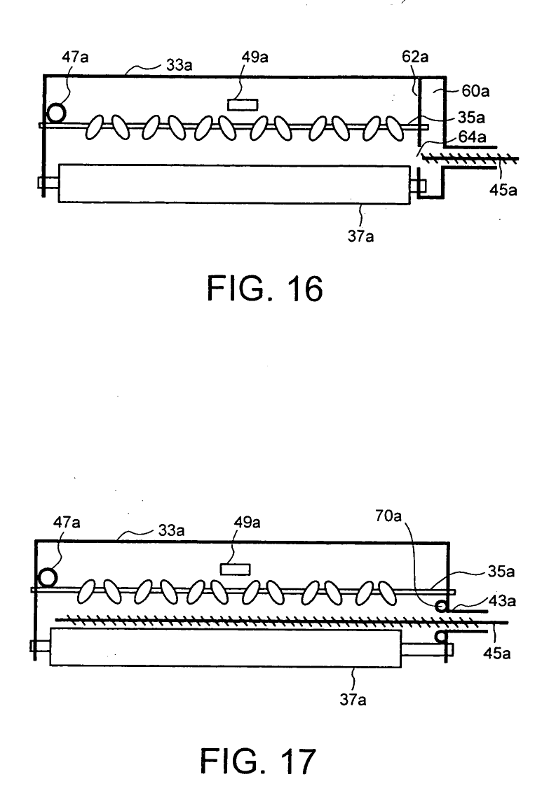

In this embodiment, a developer pool portion 60a as shown in FIG. 16 is provided near developer vent 43a of developing device 7a to regulate amount of developer discharged from developer vent 43a. Thus, it becomes not required to control a rotating angle of auger 45a.

Between developer container 33a and developer pool portion 61a, a partition 62a is provided and a connecting port 64a is provided at a specified position of partition 62a to connect developer container 33a and developer pool portion 61a. Connecting port 64a is provided at a height of the surface of developer pooled in developer container 33a. Developer exceeding the specified surface height enters into developer pool portion 60a from developer container 33a and is discharged through developer vent 43a by auger 45a.

When the structure is as described above, it is not necessary to control the operation of auger 45a so as to maintain the amount of developer in developer container 33a at a fixed level and the construction becomes simple.

Another modification of the developing device will be described taking developing device 7a as an example. In this modification, a magnetic seal 706 is provided near developer vent 43a as shown in FIG. 17.

If mixed color developers are much in developer container 33a, even when developers are replenished and discharged as well as paper dust is sufficiently reduced, mixed developers are still much. In this case, it is more economical to discharge toner only without discharging carrier. Therefore, when magnetic seal 70a composed of magnet/electromagnet is used, carrier composed of magnetic materials are not discharged from developer vent 43a but mixed non-magnetic toner only is discharged from developer vent 43a. When magnetic seal 70a is composed of electromagnet, it is possible to select whether both of toner and carrier are discharged or toner only is discharged by turning on/off current to the electromagnet by considering toner density and carrier life in developer container 33a. Further, a discharging ratio of toner and carrier can be varied according to size of current.

Magnetic seal 70a may be provided at connecting port 64a when developer pool portion 60a is provided.

In addition to the replenishing and discharging of developer according to toner density of developer in the developer container, if the developer was discharged in a specified amount temporarily when the number of sheets with images formed reaches to a certain level, developer is exchanged periodically and deterioration of developer can be avoided even when a printing ratio is low.

### THIRD EMBODIMENT

In the third embodiment, an amount of toner containing paper dust and other color toners mixing into second to fourth processing units 100b to 100d is decided based on a difference between a toner area formed by an upstream processing unit and a toner image area formed by it's own.

This will be explained taking second processing unit 100b as an example. First, a area of a toner image formed in first processing unit 100a. This area may be obtained by directly taking a picture using a CCD or other means and also, from an electrostatic latent image formed on photosensitive drums 1b to 1d.

A area of a toner image that is to be formed in second processing unit 100b is obtained from a area of an electrostatic latent image drawn by exposure unit 5b on photosensitive drum 1b.

As an area of toner images formed by first processing unit 100a is wider, toner to get into second processing unit 100b of a developing device increases more in quantity. In portions where toner images made by first processing unit 100a and those made by second processing unit 100b are overlapped, the former is prevented from reverse image transfer to photosensitive dram1b of second processing unit 100b by the latter so that no toner gets into second processing unit 100b of the developing device.

Thus, the overlapped area is subtracted from the area of toner images formed by first processing unit 100a to estimate quantity of toner which gets into second processing unit 100b and toner are replenished to or discharged from second processing unit 100b immediately after the images are formed in the case that the estimated quantity of toner is above a predetermined value.

Thus, even when a large amount of other color toners may possibly be mixed into the developing device, it becomes possible to replenish or discharge developer immediately after other color toners mixed so as to prevent next image forming from being affected by mixing of other colors.

### FOURTH EMBODIMENT

In the fourth embodiment, a high density toner image such as a solid image is developed on the photosensitive drum when an image is not formed and mixed color toners are carried out efficiently in addition to the discharging of developer by a relevant processing unit itself based on a toner density.

At this time, for example, when toner is discharged after forming a solid image in second processing unit 100b, in third processing unit 100c and fourth processing unit 100d at the downstream side, toner is transferred inversely to photosensitive drums 1c and 1d from a toner image formed in second processing unit 100b. In order to prevent this, the reverse transfer of toner is suppressed by reducing transferring current given to transfer units 9c and 9d of third processing unit 100c and fourth processing unit 100d when forming a solid mage for the purpose of discharging toner in second processing unit 100b.

Thus, the color toner mixing to third and fourth processing units 100c and 100d by discharging toner from second processing unit in the mixed color toner discharging mode can be prevented. Further, the discharged toner is removed by belt cleaner 16.

### FIFTH EMBODIMENT

Some of toners transferred inversely from a first formed toner image may be in the negatively charged state. In the fifth embodiment, a mechanism to prevent negatively charged inversely transferred other color toners from mixing in the developing device will be described.

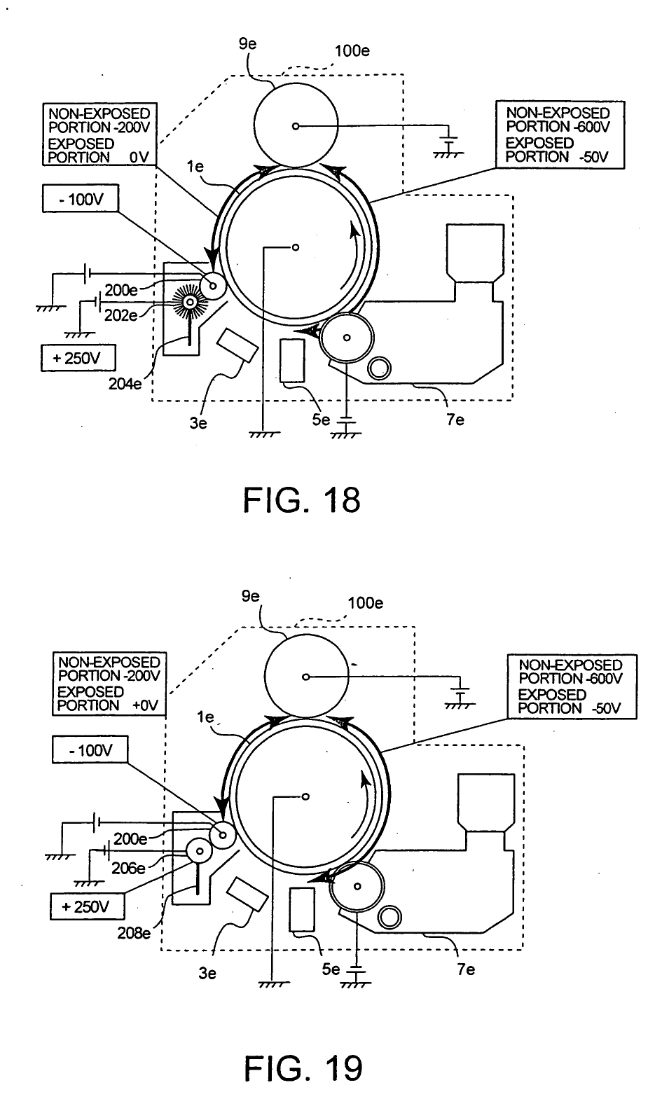

In this embodiment, a processing unit 100e shown in FIG. 18 will be used for second processing unit 100b shown in FIG. 1.

Processing unit 100e is composed of a photosensitive drum 1e, a main charger 3e, an exposure unit 5e, a developing device 7e, a transfer unit 9e, an elastic roller 100e, a brush roller 102e, and a contract member 204e.

Elastic roller 200e applied with voltage of about −199V is kept in contact with photosensitive drum 1e between the transfer position and the charging position of photosensitive drum 1e as shown in FIG. 18. Further, brush roller 202e applied with +250V is brought in contact with this elastic roller 200e.

Potential at the portion of photosensitive drum 1e charged at −600V by main charger 3e, where an electrostatic latent image is formed by exposing the image with exposure unit 5e becomes about −50V. Here, a toner that is negative charged is supplied from developing device 7e and the image is developed to a toner image and transferred onto a sheet of paper by transfer unit 9e. The potential of photosensitive drum 1e after the toner image was transferred on a sheet of paper is about −200V at the non-exposed portion and 0V or positive at the exposed portion.

Negative charged toner out of inversely transferred toners is attached to −100V voltage applied elastic roller 200e from the non-exposed portion. Remaining toner is left on the exposed portion. This toner was inversely transferred from a toner image transferred on a sheet of paper from photosensitive drum 1e itself and can be recovered by developing device 7e and is not needed to be removed by elastic roller 200e. The toner inversely transferred from other portions than that portion covered by a toner image formed in processing unit 100e is other color toner inversely transferred from a toner formed before and this toner only is removed by elastic roller 200e.

The inversely transferred toner attached to elastic roller 200e is removed with a brush roller 202 applied with +250V and will never be attached to photosensitive drum 1e again.

Here, elastic roller 200e was brought to contact with photosensitive drum 1e. However, this contact member 204e can be a brush if toner can be thoroughly removed from photosensitive drum 1e.

Thus, as an inversely transferred toner retaining means like elastic roller 200e is provided, it becomes possible to prevent color mixing because negative charged inversely transferred tone does not enter into developing device 7e in a processing unit using the cleaner-less processing.

Toner attached to brush roller 202e can be removed by providing a contact member 204e at the position contacting brush roller 202e as shown in FIG. 18.

Further, a removing roller 206e may be provided for brush roller 202e and a removing blade 202e may be brought in contact with removing roller 206e as shown in FIG. 19. Thus, it becomes possible to further extend the service life than a combination of brush roller 202e with contact member 204e.

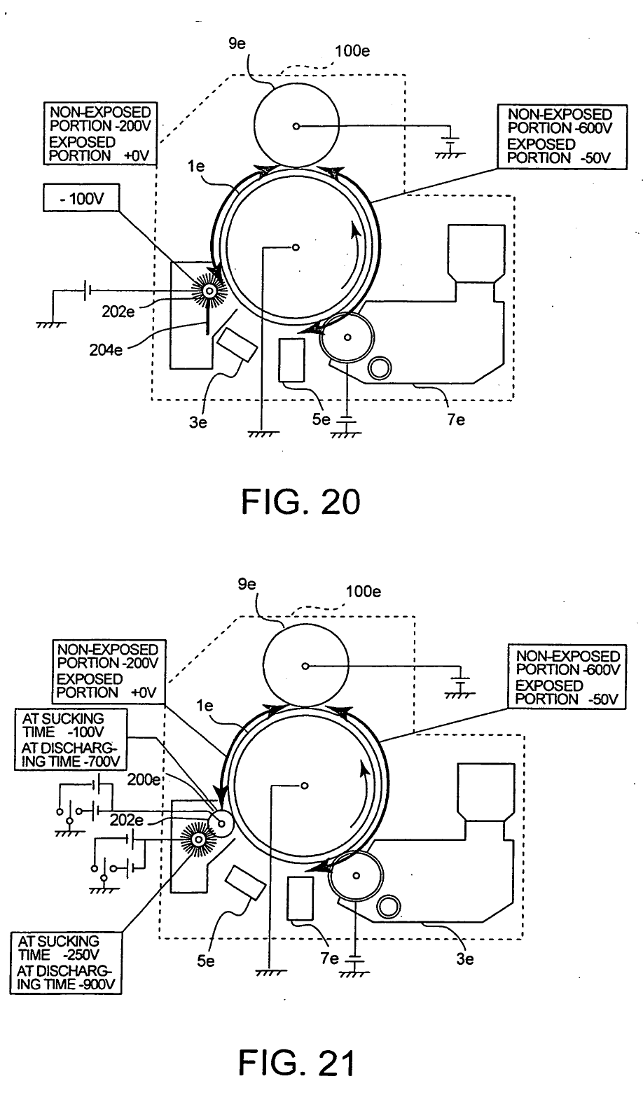

Brush roller 202e applied with −100V voltage may be brought in contact with photosensitive drum 1e without providing elastic roller 200e as shown in FIG. 20.

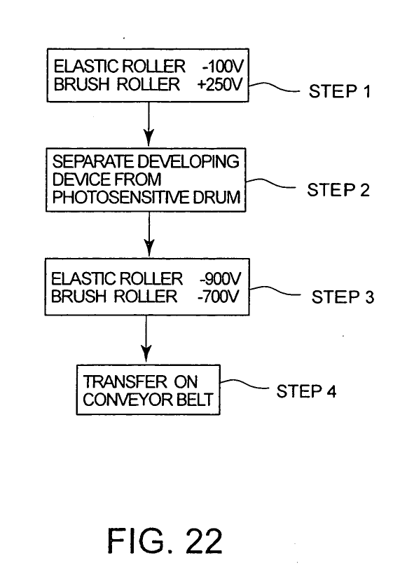

The structure shown in FIG. 21 is less contact member 204e differing from the structure shown in FIG. 18. The apparatus is so controlled that toners attached to brush roller 202e is removed by varying voltage applied to brush roller 202e and elastic roller 200e without bringing contact member 204e in contact with brush roller 202e. This control will be explained referring to FIG. 22.

Inversely transferred toner is removed by bringing elastic roller 200e applied with −100V voltage in contact with photosensitive drum 1e. Voltage applied to brush roller 202e at this time, is +250V (Step 1).

When it is desired to remove toner attached to brush roller 202e, first separate developing device 7e from photosensitive drum 1e so that a developing roller 37e does not recover toner from photosensitive drum 1e (Step 2).

Then, applied voltage to brush roller 202e is varied to −900V and −700V voltage is applied elastic roller 200e (Step 3).

Toner retained on brush roller 202e is moved to elastic roller 200e and toner on elastic roller 200e is discharged to photosensitive drum 1e.

The discharged toner is transferred on conveyor belt 13 from photosensitive drum 1e and this toner is removed by belt cleaner 16.

By controlling the apparatus in this way, it becomes unnecessary to bring contact member 204 into contact with brush roller 202e and a long service life can be maintained.

As described above, when the cleaner-less process and developer discharging are used in combination, it is possible to maintain the less consumption of toners and prevent deterioration of developer without reducing the life of photosensitive drum 1a.

(Tests)

With the developing device in the first embodiment incorporated into a first processing unit 100a, an test shown below was conducted.

Under the environment of temperature 21° C. and humidity 50%, a developer 2009 of toner density of 75 wt % was put in developer container 33a. Bias current applied to transfer unit 9a was set at 10 μA.

The printing rate indicating a rate of an actually formed toner image area against the maximum toner image area that can be formed by this image forming apparatus on one sheet of A4 paper was set at 5% and an test was conducted on a case when auger 45a was operated and a case when an auger 45a was stopped; that is, when developer is discharged through developer vent 43a and when developer is not discharged. When developer was discharged, developer was replenished through developer replenishing port and when not discharged, toner only was replenished and amount of developer in developer container 33a was kept at a constant level. In order to compare a means to remove residual toner attached to photosensitive drum 1a with a means adopting a cleaner-less processing as in this embodiment, an embodiment was also conducted for a case when a cleaner 12a to scrape residual toner off photosensitive drum 1a is installed.

To observe the image status changing every time when an image was formed, the image formation was made on 10,000, 20,000, 30,000 and 40,000 sheets of A4 size paper and each time the image state was visually judged. The results of this observation are shown in Table 1. Test No. 4 corresponds to developing device 7a in the first embodiment.

TABLE 1

| Test | Print | Developer | | No. of printed sheets | | | | Toner |
|---|---|---|---|---|---|---|---|---|
| No. | Rate | discharging | Cleaner | 10,000 | 20,000 | 30,000 | 40,000 | consumption |
| 1 | 5% | Stop | Yes | ◯ | ◯ | X | | 20 g/1,000 |
| | | | | | | | | sheets |
| 2 | | | No | ◯ | X | | | 17 g/1,000 |
| | | | | | | | | sheets |
| 3 | | Operate | Yes | ◯ | ◯ | ◯ | ◯ | 30 g/1,000 |
| | | | | | | | | sheets |
| 4 | | | No | ◯ | ◯ | ◯ | ◯ | 25 g/1,000 |
| | | | | | | | | sheets |

X: Fogging generated

At the point of time when the image forming on 20,000 sheets under the condition of Test No. 2 using the cleaner-less processing without discharging developer through developer vent 43a, the image fogging was generated. Also, under the condition of Test No. 1 with cleaner 12a installed without discharging developer, the image fogging was generated at the point of time when the image forming of 30,000 sheets was completed.

On the contrary, when developer was discharged, the image deterioration shown above was not recognized when the image formation on 40,000 sheets of paper was completed under either the condition in Test No. 4 of the cleaner-less processing or the condition in Test 3 with cleaner 12a installed.

When the toner consumption shown in Tale 1 under the condition in Test No. 3 was compared with that under the condition in Test No. 4, the toner consumption under the condition in Test No. 4 with the cleaner-less process adopted was less. Further, as clearly seen in FIG. 15 showing the comparison results of scraping amounts of the surface of photosensitive drum 1a for availability of cleaner 12a, the scraping amount of the surface of photosensitive drum 1a can be made less when the cleaner-less processing was adopted and the life of photosensitive drum 1a can be extended.

Accordingly, when the cleaner-less processing was used to discharge developer by providing developer vent 43a to developer container 33a, toner consumption can be maintained at the low level and deterioration of developer can be prevented without reducing the life of photosensitive drum 1a.

(Test 2)

In the first embodiment, the printing rate was set as low as 1% and frequency of developer discharging based on toner density in developer container 33a was reduced. Under this state, developer was replenished and discharged according to toner density of developer in developer container 33a. The results of this test are shown as Test No. 5.

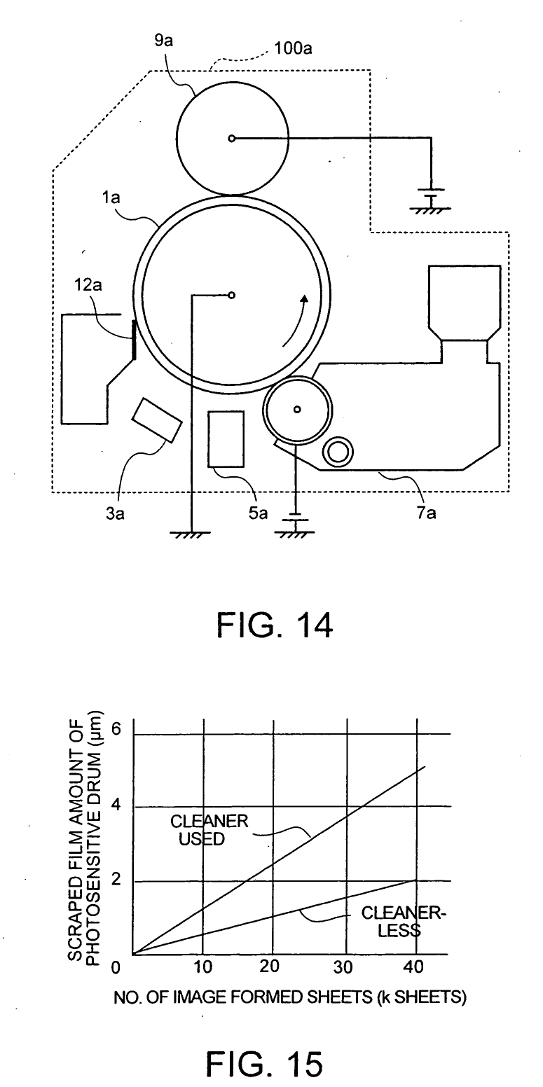

Further, the test results conducted with cleaner 12a installed for scraping off residual toner on photosensitive drum 1a as shown in FIG. 14 are shown as Test No. 6. In Test No. 7, paper powder and dust were discharged by executing the solid image formation of 100% printing rate for one A4 size sheet of paper for the image forming of every 50 sheets and toner was replenished through developer replenishing port 47a. In Test No. 8 corresponding to the developer discharging method explained in the first embodiment, developer was discharged through developer vent 43a for every image forming of 100 sheets and the same amount of developer was replenished through developer replenishing port 47a. The results of this test are shown in Table 2.

TABLE 2

| Test | Print | Developer | | No. of printed sheets | | | | Interim |
|---|---|---|---|---|---|---|---|---|
| No. | Rate | discharging | Cleaner | 10,000 | 20,000 | 30,000 | 40,000 | discharge |
| 5 | 1% | Operate | No | ◯ | X (A) | | | |
| 6 | | | Yes | ◯ | ◯ | ◯ | X (B) | |
| 7 | | | No | ◯ | ◯ | ◯ | ◯ | Solid print |
| | | | | | | | | 50 sheets |
| 8 | | | Yes | ◯ | ◯ | ◯ | ◯ | 1 g/100 |
| | | | | | | | | sheets |

X: Fogging generated

In Test No. 5 wherein developer was replenished or discharged according to only toner density of developer in developer container 33a, the image fogging was already recognized at the point of time when the image forming was completed on 20,000 sheets. Under the condition in Test No. with cleaner 12a provided, the image fogging was generated for deterioration of developer at the time when the image forming was completed on 30,000 sheets.

Under the condition in Test No. 7 wherein a solid image was formed for the image forming of every 50 sheets, no improper image formation was resulted even when the image formation of 40,000 sheets was completed.

Further, under the conditions of Test No. 8 wherein developer was replenished/discharged for every 100 sheets, defective image forming was not resulted when the image forming of 40,000 sheets was complete. It is considered that more high effect is obtained when the solid image forming is combined with the developer replenishing and discharging.

As described above, when developer is not only replenished/discharged according to its density in developer container 33a but also is discharged in a specified amount temporarily when a number of sheets with an image formed reaches a certain level, developer is exchanged periodically and therefore, it becomes possible to maintain developer unchanged without deteriorated even when a printing rate is low.

(Test 3)

The test was conducted by operating first processing unit 100a and second processing unit 100b as shown below.

An yellow toner image was formed on paper with first processing unit 100a by changing a printing rate to 3%, 5% and 10%. Further, the printing pattern of a magenta image that is formed with second processing unit 100b was adjusted to the printing rate 5% so that it does not overlapped on the toner image formed on paper by first processing unit 100a. Further, the similar test was also conducted for a case when developer was discharged in processing unit 100b at the printing rate 10%.

Because a toner image formed by first processing unit 100a does not overlap on a toner image formed by second processing unit 100b, an amount of toner corresponding to the printing rate of first processing unit 100a is inversely transferred and mixes into toner in second processing unit 100b. On the other hand, in second processing unit 100b, toner is discharged as a toner image is formed on paper. Under these states, changes in color tone of an image formed on 5,000, 10,000 and 1,5000 sheets were observed. The results are as shown in Table 3.

TABLE 3

| | Printing rate | | No. of printed sheets | | | | |
|---|---|---|---|---|---|---|---|
| Test | 1st | 2nd | Developer | | | | |
| No. | proces unit | proces unit | discharging | 5,000 | 10,000 | 15,000 | 20,000 |
| 9 | 3% | 5% | Stop | ◯ | ◯ | Mixed | |
| | | | | | | Color | |
| 10 | 5% | | | ◯ | Mixed | | |
| | | | | | Color | | |
| 11 | 10% | | | Mixed | | | |
| | | | | Color | | | |
| 12 | | | Operate | ◯ | Mixed | | |
| | | | | | Color | | |

X: Fogging generated

In Test No. 9 wherein the developer discharge was stopped in second processing unit 100b and the printing rate was 3% in first processing unit 100a, the color tone change was confirmed at the 15,000th sheet. The color tone change was confirmed at the 10,000th sheet in Test No. 10 of the printing rate 5% and 5th sheet in Test No. 11 of the printing rate 10%. The more larger the toner image area formed in first processing unit 100a was, the more faster the color tone change appeared.

On the other hand, in Test No. 12 corresponding to the third embodiment; that is, when developer was discharged in second processing unit 100b and the printing rate in first processing unit 100a was 10%, no color tone change was observed until 10th sheet. From this result, it is seen that the color mixing of toner can be delayed when developer is discharged.

(Test 4)

In order to substantiate the fourth embodiment, the test shown below was conducted. Table 4 shows the change in transfer efficiency showing what % of toner on a toner image formed on a sheet of paper in first processing unit 100a corresponding to the transfer current of second processing unit 100b is inverse transferred to photosensitive drum 1c of third processing unit 100c.

TABLE 4

| | Printing rate | | No. of printed sheets | | | | |
|---|---|---|---|---|---|---|---|
| Test | 1st | 2nd | Developer | | | | |
| No. | proces unit | proces unit | discharging | 5,000 | 10,000 | 15,000 | 20,000 |
| 13 | 10 | 5% | Stop | ◯ | ◯ | Mixed | |
| | | | | | | Color | |
| 14 | | | | ◯ | Mixed | | |
| | | | | | Color | | |
| 15 | | | | Mixed | | | |
| | | | | Color | | | |
| 16 | | | Operate | ◯ | Mixed | | |
| | | | | | Color | | |
| 17 | | | | | | | |
| 18 | | | | | | | |

X: Fogging generated

According to this, it can be seen that the inverse transfer of the first yellow color toner image or the inverse transfer form the second color magenta toner image was below 0.1% when transfer current is below 5 μA and single transferring toner amount can be made small by suppressing transfer current.

(Test 5)

The test shown below was conducted on the toner removing mechanism explained in the fifth embodiment as shown below using processing unit 100e shown in FIG. 18 instead of second processing unit 100b shown in FIG. 2. The printing rate of an yellow toner image that is formed on a sheet of paper in first processing unit 100a was set at 10%. Further, the print pattern of a magenta toner image that is formed in processing unit 100e is regulated so as to make the printing rate constant at 5% in processing unit 100e so that a magenta toner image is not overlapped on the toner image formed on a sheet of paper in first processing unit 100a. Under this state, the color tone change of images when formed on 5,000 sheets, 10,000 sheets and 15,000 sheets were observed. The results are as shown in Table 5.

TABLE 5

| | | | | Removing | | | | |
|---|---|---|---|---|---|---|---|---|
| | Printing rate | | | toner | | | | |
| Test | 1st proces | 2nd proces | Developer | Structure | No. of printed sheets | | | |
| No. | unit | unit | Discharging | of member | 5,000 | 10,000 | 15,000 | 20,000 |
| 13 | 10% | 5% | Stop | None | Mixed | | | |
| | | | | | Color | | | |
| 14 | | | | Rotary brush + contact | ◯ | Mixed | | |
| | | | | member | | Color | | |
| 15 | | | | Elasticroller + Rotary | ◯ | ◯ | Mixed | |
| | | | | brush + Removing | | | Color | |
| | | | | blade | | | | |
| 16 | | | | Elasticroller + Rotary | ◯ | ◯ | ◯ | Mixed |
| | | | | brush + Removing | | | | Color |
| | | | | blade | | | | |
| 17 | | | | Elasticroller + Rotary | ◯ | ◯ | ◯ | Mixed |
| | | | | brush | | | | Color |
| 18 | | | Operate | (Discharging brush) | ◯ | ◯ | ◯ | ◯ |

In Test No. 13 wherein no toner removing mechanism was provided, the mixed color was observed when completing the image forming on 5,000 sheets of paper while in Test No. 14 wherein the toner removing mechanism comprising brush roller 202e and contact member 204e as shown in FIG. 20 was provided, the mixed color was not conspicuous at that time. In Test No. 15 wherein elastic roller 200e was provided between brush roller 202e and photosensitive drum 1e as shown in FIG. 18, mixed color was not observed further until 10,000 sheets.

In Test No. 16, the toner was removed with removing roller 206e kept contacted to elastic roller 200e and removing blade 208e kept contacted to removing roller 206e as shown in FIG. 19, and no mixed color was confirmed until 15,000 sheets.

In Test No. 17, a test was conducted in the structure using elastic roller 200e and brush roller 202e and toner was removed from brush roller 202e without using contact member 204e but by controlling voltage applied to elastic roller 200e and brush roller 202e as shown in FIG. 21. Whenever the image forming was executed on 50 sheets of paper, voltage applied to elastic roller 200e and brush roller 202e was varied and toner was discharged for two rotations of photosensitive drum. In this test, the mixed color was not recognized until 15,000 sheets likewise Test No. 16. In Test No. 18 which combined Test No. 17 with the developer discharging based on toner density in developing device 7e, the mixed color was also not recognized at the point of time when the image forming on 20,000 sheets was completed.

When a toner removing mechanism described above is provided, it is possible to suppress the progress of color mixing even when the number of image forming sheets is increased.

In the above description, the configuration wherein processing units installed by aligning them in the conveying direction of sheets of paper conveyed by conveyor belt 13 was explained but it is not restricted to this, and needless to say, the present invention is also applicable to a configuration adopting an intermediate transferring element system to transfer an image once transferred to an intermediate transferring element again to sheets of paper collectively.

According to the present invention, it is possible to obtain an image forming apparatus capable of successively forming clear images by preventing deterioration of developer for mixture of paper dust and efficiently discharging mixed color toner in the color image formation.

Further, according to the present invention, it is possible to obtain an image forming apparatus capable of successively forming clear images by efficiently discharging mixed color toner and preventing mixture of toner.

In addition, according to the present invention, it is possible to obtain an image forming apparatus capable of successively forming clear images by preventing mixture of other color toners into a developing device and efficiently using toners.

1. An image forming apparatus comprising:
an image carrier;
a main charger to uniformly charge the image carrier;
an exposure unit to form an electrostatic latent image by exposing the image carrier charged by the main charger;
a developing device, having a developer vent and a developer replenishing port to replenish developer to the developing device, to form a toner image by developing the electrostatic latent image on the image carrier with two-component developer including toner and carrier; and
a transfer unit to transfer the toner image onto an image receiving medium,
wherein the developing device removes residual toner remained on the image carrier after transferring the toner image by the transfer unit and discharges paper dust mixed into the developing device when removing the residual toner through the developer vent together with the carrier.

2. The image forming apparatus as set force in claim 1, wherein the developing device has an auger to convey the developer to the developer vent.

3. The image forming apparatus as set force in claim 1, wherein the developing device includes:
a developer container to pool the developer;
a developer pool portion to once pool the developer over flown from the developer container and to be discharged;
a partition to divide the developer pool portion and the developer container; and
a connecting port provided at a height of the stratification surface of the developer to be pooled in the developer container provided on the partition.

4. The image forming apparatus as set force in claim 1, wherein the developing device has a magnetic seal at the developer vent.

5. The image forming apparatus as set force in claim 1, wherein the developing device has a toner density detector to detect toner density of the developer, and discharges the developer through the developer vent based on the toner density detected by the toner density detector.

6. The image forming apparatus as set force in claim 1, wherein the developing device forms a solid image in a non-printing operation and the transfer unit transfers the solid image to the image receiving medium to consume the toner.

7. The image forming apparatus as set force in claim 1, wherein the developing device forms a solid image to consume the toner resulting discharge the toner and replenishes toner and carrier through the developer replenishing port in an independent amount, respectively.

8. The image forming apparatus as set force in claim 1, wherein the developing device discharges developer through the developer vent based on the number of sheets with an image formed.

9. The image forming apparatus as set force in claim 1, wherein the developing device discharges developer through the developer vent based on an integrated value of a non-printed area.

10. An image forming apparatus comprising:
a first image carrier;
a first main charger to charge the first image carrier;
a first exposure unit to form a first electrostatic latent image by exposing the first image carrier charged by the first main charger;
a first developing device containing a first developer including a first toner and carrier and develops the first electrostatic latent image formed on the first image carrier with the first toner to form a first toner image;
a first transfer unit to transfer the first toner image onto an image receiving medium from the first image carrier;
a second image carrier;
a second main charger to charge the second image carrier;
a second exposure unit to form a second electrostatic latent image by exposing the second image carrier charged by the second main charger;
a second developing device, having a developer vent and a developer replenishing port, and containing a second developer including a second toner and carrier, to develop the second electrostatic latent image formed on the second image carrier with the second toner, wherein the second developing device removes the first and second toners adhered to the second image carrier from the second image carrier and discharges the removed first toner and the second developer with the second toner mixed through the developer vent; and
a second transfer unit to transfer the second toner image developed by the second developing device onto the image receiving medium onto which the first toner image already transferred.

11. The image forming apparatus as set force in claim 11, wherein the second developing device discharges developer based on a value obtained by subtracting an area of a portion wherein the first toner image and the second toner image are overlapped each other from the area of the first toner image.

12. The image forming apparatus as set force in claim 10, wherein the second developing device forms an image in the non-printing operation and the second transfer unit discharges toner from the second developing device by transferring the image onto the image receiving medium resulting consuming the second toner.

13. The image forming apparatus as set force in claim 12 further comprising a third transfer unit, provided at downstream side from the second transfer unit, to transfer a third toner image onto the image receiving medium onto which the first and second toner images already transferred, wherein the third transfer unit is applied a transfer current which is lower than the one at the time of normal image formation when the image receiving medium passes the third transfer unit.

14. An image forming apparatus comprising:
a first image carrier;
a first main charger to charge the first image carrier;
a first exposure unit to form a first electrostatic latent image by exposing the first image carrier charged by the first main charger;
a first developing device to develop the first electrostatic latent image formed on the first image carrier to form a first toner image with a first toner;
a first transfer unit to transfer the first toner image onto an image receiving medium from the first image carrier;
a second image carrier;
a second main charger to charge the second image carrier;
a second exposure unit to form a second electrostatic latent image by exposing the second image carrier charged by the second main charger;
a second developing device to develop the second electrostatic latent image formed on the second image carrier by the second exposure unit, wherein the second developing device removes the first toner and the second toner adhered to the second image carrier from the second image carrier and discharges the removed first toner and the second toner by forming a solid image on the second image carrier with the removed first toner and the second toner;
a second transfer unit to transfer the second toner image developed by the second developing device onto the image receiving medium on which the first toner image was already transferred from the second image carrier; and
a third transfer unit, provided at downstream side from the second transfer unit, to transfer a third toner image onto the image receiving medium onto which the first and second toner images already transferred, wherein the third transfer unit lowers the transfer current when the second toner image transferred from the second image carrier passes between the third transfer unit and the third image carrier.

15. An image forming method comprising:
uniformly charging an image carrier;
forming an electrostatic latent image by exposing the charged image carrier;
forming a toner image by developing the electrostatic latent image using two-component developer including toner and carrier by a developing device having a developer vent;
transferring the toner image onto an image receiving medium; and
removing residual toner remaining on the surface of the image carrier after transferring the toner image and discharging paper dust mixed in the developing device when removing the residual toner together with developer or the carrier through the developer vent.

16. The image forming method as set force in claim 15 further comprising:
replenishing developer to the developing device through a developer replenishing port provided to the developing device.

17. The image forming method as set force in claim 15 further comprising:
conveying the developer to the developer vent by an auger provided to the developing device.

18. The image forming method as set forth in claim 15, wherein the developing device,
pools the developer in a developer container;
once pools the developer that is over flown from the developer container and should be discharged in a developer pool portion; and
divides the developer pool portion and the developer container.

19. The image forming method as set force in claim 15, wherein the developing device does not discharge the carrier comprising a magnetic material from the developer vent by the magnetic seal provided to the developer vent.

20. The image forming method as set force in claim 15, wherein the developing device:
detects toner density in the developer; and
controls the developing device to discharge the developer through the developer vent based on the toner density.

21. The image forming method as set force in claim 15, wherein the developing device forms a solid image when no printing is made and transfers the solid image to an image receiving medium to consume the toner.

22. The image forming method as set force in claim 15, wherein the developing device, having a developer vent, consumes the toner by forming a solid image and replenishes toner and carrier in an independent amount, respectively through the developer replenishing port.

23. The image forming method as set force in claim 15, wherein the developing device discharges developer through the developer vent based on the number of image formed sheets of paper.

24. The image forming method as set force in claim 15, wherein the developing device discharges developer through the developer vent based on an integrated value of non-printed areas.

25. An image forming method comprising:
charging a first image carrier;
forming a first electrostatic latent image by exposing the charged first image carrier;
forming a first toner image with the first toner by developing the first electrostatic latent image formed on the first image carrier by a first developing device containing a first developer including a first toner and carrier;
transferring the formed first toner image onto an image receiving medium from the first image carrier;
charging a second image carrier;
forming a second electrostatic latent image by exposing the charged second image carrier;
developing the second electrostatic latent image using a second toner by a second developing device having a developer vent and containing the second developer including the second toner and carrier;
removing the first toner and the second toner adhered to the second image carrier from the second image carrier;
discharging the second developer mixing the removed first toner and the second toner through the developer vent; and
transferring the second toner image developed by the second developing device from the second image carrier onto the image receiving medium on which the first toner image was already transferred.

26. The image forming method as set force in claim 25, wherein the second developing device discharges the developer based on a value of an area of the first toner image subtracted an area of a portion where the first toner image and the second toner image are overlapped each other.

27. The image forming method as set force in claim 25, wherein the second developing device forms an image when no printing is made and consumes the second toner by transferring the image onto the image receiving medium.

28. An image forming method comprising:
charging a first image carrier;
forming a first electrostatic latent image by exposing the charged first image carrier;
forming a first toner image using a first toner from the first electrostatic latent image by a first developing device;
transferring the first toner image onto an image receiving medium from the first image carrier;
charging a second image carrier;
forming a second electrostatic latent image by exposing the charged second image carrier;
forming a second toner image by developing the second electrostatic latent image by a second developing device, removing the first toner and the second toner adhered to the second image carrier therefrom, consuming the second toner mixing the first toner by forming a solid image on the second image carrier; and
transferring the second toner image developed by the second developing device onto the image receiving medium on which the first toner image was already transferred from the second image carrier;
wherein the second transfer unit lowers transfer current when the first toner image transferred from the first image carrier passes between the second transfer unit and the second image carrier.

29. An image forming apparatus comprising:
charging means for uniformly charging an image carrier;
exposing means for forming an electrostatic latent image by exposing the image carrier charged by the charging means;
developing means, having a developer vent, for forming a toner image on the image carrier with two-component developer including toner and carrier; and
transfer means for transferring the toner image onto an image receiving medium,
wherein the developing means removes residual toner remained on the image carrier after transferring the toner image by the transfer means and discharges paper dust mixed into the developing means when removing the residual toner through the developer vent together with the carrier.

30. An image forming apparatus comprising:
first charging means for charging a first image carrier;
first exposure means for forming a first electrostatic latent image by exposing the first image carrier charged by the first charging means;
first developing means containing a first developer including a first toner and carrier for developing the first electrostatic latent image formed on the first image carrier with the first toner to form a first toner image;
first transfer means for transferring the first toner image onto an image receiving medium from the first image carrier;
second charging means for charging a second image carrier;
second exposure means for forming a second electrostatic latent image by exposing the second image carrier charged by the second charging means;
second developing means, having a developer vent and a developer replenishing port, and containing a second developer including a second toner and carrier, for developing the second electrostatic latent image formed on the second image carrier with the second toner, wherein the second developing means removes the first and second toners adhered to the second image carrier from the second image carrier and discharges the removed first toner and the second developer with the second toner mixed through the developer vent; and
second transfer means for transferring the second toner image developed by the second developing means onto the image receiving medium onto which the first toner image already transferred.
